(19) United States
(12) Patent Application Publication
(10) Pub. No.: US 2012/0331096 A1
(43) Pub. Date: Dec. 27, 2012

(54) TELECOMMUNICATIONS TERMINAL, BROADCAST RECEIVING TERMINAL AND COMPUTER PROGRAM

(75) Inventors: Masashi YAMAGUCHI, Osaka (JP); Kazuhiko KAWAMOTO, Osaka (JP)

(73) Assignee: Panasonic Corporation, Osaka (JP)

(21) Appl. No.: 13/413,967

(22) Filed: Mar. 7, 2012

(30) Foreign Application Priority Data
Jun. 27, 2011 (JP) 2011-141362

(51) Int. Cl. G06F 15/16

(52) U.S. Cl. 709/217

(57) ABSTRACT

The telecommunications terminal is connected to a management server and a broadcast receiving terminal to communicate with each other. The broadcast receiving terminal stores an identifier to identify itself uniquely and the address of the server, which stores information about correspondence between the identifier and the address of a predetermined portal site. The telecommunications terminal includes: a processor which generates a first transmission request for transmission of the identifier and the server's address and a second transmission request for transmission of the portal site's address; and a communications unit that communicates with the broadcast receiving terminal and the server. After having sent the first transmission request to the broadcast receiving terminal, the communications unit receives the identifier and the server's address from the broadcast receiving terminal, when the communications unit sends the second transmission request and the identifier to the server, thereby receiving the portal site's address from the server.

### BACKGROUND

1. Technical Field

The present disclosure relates to a telecommunications terminal and broadcast receiving terminal for use in a system in which the telecommunications terminal, the broadcast receiving terminal and a management server are connected together so as to communicate with each other. More particularly, the present disclosure relates to a technique for making the telecommunications terminal and the broadcast receiving terminal join forces to get the address of a portal site that is stored in the management server.

2. Description of the Related Art

Recently, digital broadcast receiving terminals, in which a modem to connect the terminals to a network has been built and in which a browser that allows the user to search the network for any kind of information he or she is looking for has been installed, have become immensely popular nowadays. The digital broadcast receiving terminal may be a set top box (STB) for use to view a CATV program, for example. Using such a digital broadcast receiving terminal that is connected to a network, more and more users can now access a portal site in the area where the digital broadcast receiving terminal is set up and use various contents and interactive application services related to that area.

Meanwhile, thanks to rapid development of IT (information technologies), various mobile telecommunications terminals such as a high-performance portable tablet computer have also become widely popular. Such a mobile telecommunications terminal can be connected to the Internet over a high-speed network such as WiFi (IEEE 802.11 Series). With such a mobile telecommunications terminal, more and more users can now enjoy various contents and interactive application services, which has become an increasingly general trend these days.

Furthermore, various schemes for performing an appropriate service control when the user is using various services via a client terminal that is connected to a network have also been developed. For example, Japanese Laid-Open Patent Publication No. 2003-271555 discloses a method for making a directory server perform an access control based on user ID (identification data).

### SUMMARY

A telecommunications terminal according to one embodiment is connected to a management server and a broadcast receiving terminal so as to communicate with each other. The broadcast receiving terminal stores an identifier to identify itself uniquely and the address of the management server. The management server stores information about correspondence between the identifier and the address of a predetermined portal site. The telecommunications terminal includes: a processor which generates a first transmission request for transmission of the identifier and the address of the management server and a second transmission request for transmission of the address of the predetermined portal site; and a communications unit that communicates with the broadcast receiving terminal and the management server. After having sent the first transmission request to the broadcast receiving terminal, the communications unit receives the identifier and the address of the management server from the broadcast receiving terminal, when the communications unit sends the second transmission request and the identifier to the management server, thereby receiving the address of the predetermined portal site from the management server.

A broadcast receiving terminal according to another embodiment receives a broadcast signal and is connected to a management server and a telecommunications terminal so as to communicate with each other. The management server stores information about correspondence between an identifier to identify the broadcast receiving terminal uniquely and the address of a predetermined portal site. The telecommunications terminal is able to access the predetermined portal site by getting the address of the management server through a predetermined procedure, accessing the management server, and getting the address of the predetermined portal site from the management server. The broadcast receiving terminal includes: a storage that stores the identifier and the address of the management server; a communications unit that receives a request for transmission of the identifier and the address of the management server from the telecommunications terminal; and a processor that retrieves the identifier and the address of the management server from the storage on receiving the transmission request and that transmits the identifier and the address of the management server via the communications unit.

A computer program according to another embodiment is to be executed by a computer that is built in a telecommunications terminal. The telecommunications terminal is connected to a management server and a broadcast receiving terminal so as to communicate with each other. The broadcast receiving terminal stores an identifier to identify itself uniquely and the address of the management server. The management server stores information about correspondence between the identifier and the address of a predetermined portal site. The computer program is defined to make the computer built in the telecommunications terminal perform the steps of: sending a first transmission request for transmission of the identifier and the address of the management server to the broadcast receiving terminal; receiving the identifier and the address of the management server from the broadcast receiving terminal; sending the identifier and a second transmission request for transmission of the address of the predetermined portal site to the management server; and receiving the address of the predetermined portal site from the management server.

In one embodiment of the present disclosure, the processor of the telecommunications terminal generates a first transmission request for transmission of an identifier and the address of a management server and a second transmission request for transmission of the address of a predetermined portal site. The communications unit communicates with a broadcast receiving terminal and the management server. After having sent the first transmission request to the broadcast receiving terminal, the communications unit receives the identifier and the address of the management server from the broadcast receiving terminal, when the communications unit sends the second transmission request and the identifier to the management server, thereby receiving the address of the predetermined portal site from the management server. As a result, the portal site related to the area where the broadcasting receiving terminal is set up can be accessed with the user's trouble of entering or finding the address of the target portal site saved and with the load on the mobile telecommunications terminal lightened significantly.

Other features, elements, processes, steps, characteristics and advantages of the present disclosure will become more apparent from the following detailed description of preferred embodiments of the present disclosure with reference to the attached drawings.

### BRIEF DESCRIPTION OF THE DRAWINGS

FIG. 1 illustrates a configuration for a bidirectional broadcasting service system 1 as a first embodiment of the present disclosure.

FIG. 2 is a block diagram illustrating a configuration for the broadcast receiving terminal of the first embodiment.

FIG. 3 is a block diagram illustrating a configuration for the mobile telecommunications terminal of the first embodiment.

FIG. 4 illustrates an exemplary hardware configuration that can be used in common for each of the broadcast receiving terminal 100 and the mobile telecommunications terminal 120.

FIGS. 5A and 5B show the structure of the data that is stored in the management server of the first embodiment.

FIG. 6 is a flowchart showing the procedure of URL getting processing to be carried out by the mobile telecommunications terminal according to the first embodiment of the present disclosure.

FIG. 7 is a flowchart showing the procedure of URL request response processing to be carried out by the broadcast receiving terminal according to the first embodiment of the present disclosure.

FIG. 8 is a flowchart showing the procedure of URL request response processing to be carried out by the management server according to the first embodiment of the present disclosure.

FIGS. 9A and 9B show the structure of the data stored in the management server according to a second embodiment of the present disclosure.

FIG. 10 is a flowchart showing the procedure of URL getting processing to be carried out by the mobile telecommunications terminal according to the second embodiment of the present disclosure.

FIG. 11 is a flowchart showing the procedure of URL request response processing to be carried out by the management server according to the second embodiment of the present disclosure.

### DETAILED DESCRIPTION OF EMBODIMENTS

Assume that the user attempts to get his or her mobile telecommunications terminal connected to a portal site in the area where a broadcast receiving terminal is set up, he or she sometimes needs to enter the URL (uniform resource locator) of the target site directly into the browser, which is very troublesome for him or her. In addition, if the URL entered is wrong even by a single letter, he or she cannot access that site successfully. In that case, he or she has to check out the URL once again and reenter the correct one. This is also a time-consuming job.

To avoid such a situation, the user ID of the user's mobile telecommunications terminal may be associated in advance with the URL of his or her target portal site and then that URL may be registered with a management server that provides broadcasting services as disclosed in Japanese Laid-Open Patent Publication No. 2003-271555. However, to use that technique effectively, the user needs to choose and register a proper portal site in the area where the broadcast receiving terminal that is used by him or her to receive broadcasting services is set up. No matter whether the user him- or herself or the broadcasting service provider in the area where the management server is managed needs to do that, it will take a lot of time and trouble to get such registration done.

Alternatively, the IP (Internet Protocol) address of a target site could be registered in advance with a mobile telecommunications terminal. However, if the user purchases a retailed mobile telecommunications device not via a broadcaster that holds the IP address information, actually it is very difficult to get the IP address registered in advance with such a retailed mobile telecommunications device. Even if the IP addresses could be registered in advance with retailed mobile telecommunications devices, a huge number of IP addresses should be stored in the mobile telecommunications device. The reason is that numerous broadcasting services are provided by a lot of broadcasters and that even in the broadcasting services provided by the same broadcaster, the URL of the portal site changes from one area to another. If such registration should be done in spite of these difficulties, the load on the manufacturer of mobile telecommunications terminals would be much heavier and the space left in the mobile telecommunications terminals would also be very much limited. On top of that, the user would also have to do a time-consuming job of finding the URL of the target portal site in his or her area by searching a huge number of IP addresses registered.

In accordance with the teachings of the present disclosure, a mobile telecommunications terminal and a broadcast receiving terminal are provided. The broadcast receiving terminal can save the user the trouble of entering or finding the address of the target portal site and can get the address of the portal site related to the area where the broadcasting receiving terminal is set up from a management server with the load on the mobile telecommunications terminal lightened significantly.

Hereinafter, preferred embodiments of a telecommunications terminal and broadcast receiving terminal according to the present disclosure will be described with reference to the accompanying drawings.

### Embodiment 1

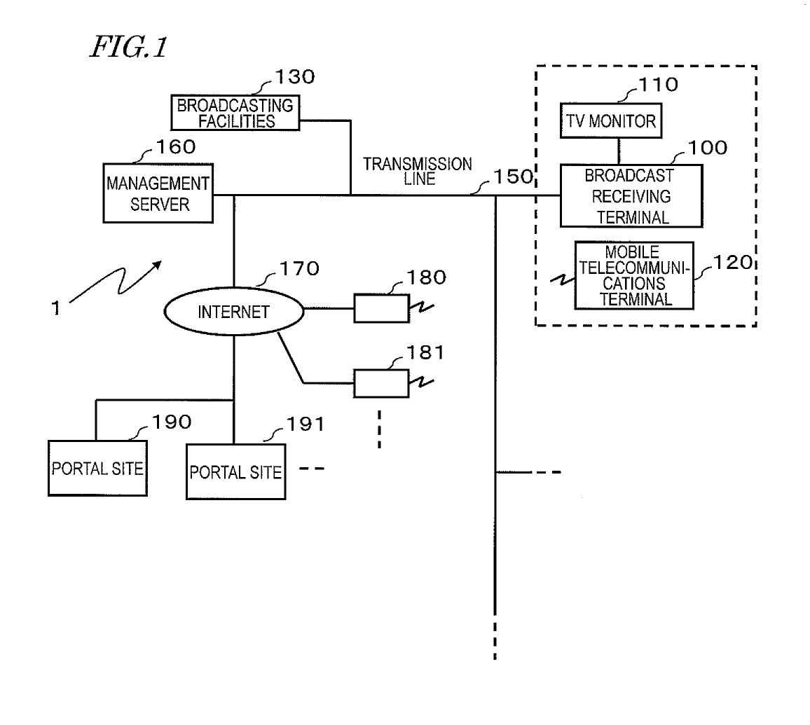

FIG. 1 illustrates a configuration for a bidirectional broadcasting service system 1 as a first specific exemplary embodiment of the present disclosure.

This broadcasting service system 1 includes a broadcast receiving terminal 100, a TV monitor 110, a mobile telecommunications terminal 120, broadcasting facilities 130, a transmission line 150, and a management server 160. In FIG. 1, also illustrated are the Internet 170, wireless access points 180 and 181, and portal sites 190 and 191. Although the broadcasting service system 1 of this embodiment is supposed to include all of these components, not all of them have to be included in the broadcasting service system 1.

The broadcast receiving terminal 100 and the TV monitor 110 are set up in a user's house that is indicated by the dashed square in FIG. 1. The broadcast receiving terminal 100 receives a broadcast signal from the broadcasting facilities 130 through the transmission line 150, and processes and displays it on the TV monitor 110. In this manner, the user can view and listen to the broadcast received.

Also, using either a built-in modem or an external modem, the broadcast receiving terminal 100 is connected to the Internet 170 through the transmission line 150 and can access various portal sites including the portal sites 190 and 191.

Examples of the mobile telecommunications terminals 120, include general-purpose tablet computers and mobile telecommunications and information display terminals such as cellphones and smart phones. Although the telecommunications terminals 120 are labeled herein as “mobile” ones, the telecommunications terminals 120 do not have to be mobile ones. Rather, any other general telecommunications terminal may be used as the telecommunications terminal 120.

The mobile telecommunications terminal 120 and the broadcast receiving terminal 100 join forces to access a portal site related to an area where the broadcast receiving terminal 100 is set up.

Specifically, in accordance with the user's instruction, the mobile telecommunications terminal 120 accesses the broadcast receiving terminal 100. In this case, the mobile telecommunications terminal 120 may access the broadcast receiving terminal 100 either through wireless access points such as Wi-Fi (including the access points 180 and 181) and the Internet 170 or in a local environment such as the user's house with a wireless modem connected to the broadcast receiving terminal 100. The mobile telecommunications terminal 120 may access the broadcast receiving terminal 100 either by automatic connection technology such as UPnP (universal plug and play) or by getting the IP address of the broadcast receiving terminal 100.

In the following example, the mobile telecommunications terminal 120 is supposed to access the broadcast receiving terminal 100 in a local environment such as the user's house. However, the mobile telecommunications terminal 120 may naturally access the broadcast receiving terminal 100 by using Wi-Fi or any other access points outside of the user's house, although description thereof will be omitted herein.

In response to the access request from the mobile telecommunications terminal 120, the broadcast receiving terminal 100 transmits its own unique identifier and the address of the management server 160 (which will be referred to herein as the “URL (uniform resource locator)”) to the mobile telecommunications terminal 120. On receiving the identifier and the management server's (160) URL, the mobile telecommunications terminal 120 accesses the management server 160 using the management server's (160) URL and the broadcast receiving terminal's (100) unique identifier. The management server 160 stores a table of correspondence between the identifier of the broadcast receiving terminal 100 and the URL of a portal site related to the area where the broadcast receiving terminal 100 is set up. Also, by reference to the broadcast receiving terminal's (100) identifier that has been provided by the mobile telecommunications terminal 120, the management server 160 transmits a portal site's URL that is associated with that identifier to the mobile telecommunications terminal 120. And the mobile telecommunications terminal 120 receives that portal site's URL from the management server 160. In this manner, the mobile telecommunications terminal 120 can access the portal site.

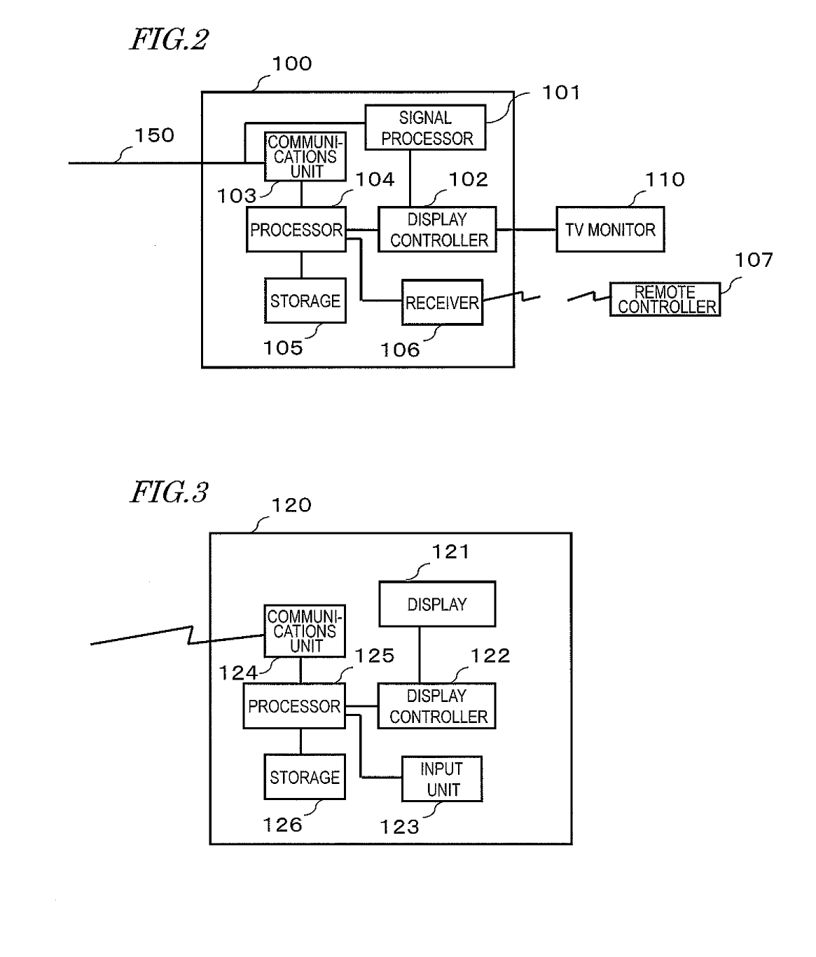

FIG. 2 is a block diagram illustrating a configuration for the broadcast receiving terminal 100 of this embodiment.

The broadcast receiving terminal 100 includes a signal processor 101, a display controller 102, a communications unit 103, a processor 104, a storage 105 and a receiver 106.

The signal processor 101 performs known signal processing on a video signal that has been received through the transmission line 150 and then sends the video signal processed to the display controller 102.

The display controller 102 performs a display control on the video signal that has been supplied from the signal processor 101, thereby displaying video on the TV monitor 110.

The receiver 106 receives a remote control signal from the user that has operated a remote controller 107 and then passes the remote control signal received to the processor 104.

In accordance with the instruction given by the processor 104, the communications unit 103 performs communications processing such as sending the remote control signal and other signals to the broadcasting facilities 130 and receiving a content from a portal site. The communications unit 103 also functions as a wireless modem and is used to access the mobile telecommunications terminal 120 in a local environment.

The processor 104 processes the remote control signal supplied from the receiver 106 and controls the signal processor 101, the display controller 102, the communications unit 103 and the storage 105. Also, in receiving a content from a portal site, the processor 104 sends an upload signal to the portal site via the communications unit 103 and receives a download signal from the portal site via the communications unit 103, subjects the download signal to predetermined processing, and then displays the portal site's content on the TV monitor 110 via the display controller 102. In making communications by the UPnP connection, for example, the processor 104 also performs its processing via the communications unit 103.

The storage 105 stores the broadcast receiving terminal's (100) own unique identifier and the URL of the management server 160. The management server's URL has been prepared and registered in advance.

The processor 104 receives a request from the mobile telecommunications terminal 120. This is a request for transmission of the broadcast receiving terminal's (100) own unique identifier and the management server's (160) URL. This transmission request will be referred to herein as a “first transmission request”. On receiving the first transmission request, the processor 104 receives the broadcast receiving terminal's (100) own unique identifier and the management server's (160) URL from the storage 105 and transmits them to the mobile telecommunications terminal 120. The communications between the broadcast receiving terminal 100 and the mobile telecommunications terminal 120 are carried out in a local environment using a wireless modem (not shown) that is connected to the broadcast receiving terminal 100. In this manner, the mobile telecommunications terminal 120 can receive the broadcast receiving terminal's (100) own unique identifier and the management server's (160) URL.

FIG. 3 is a block diagram illustrating a configuration for the mobile telecommunications terminal 120 of this embodiment.

The mobile telecommunications terminal 120 includes a display 121, a display controller 122, an input unit 123, a communications unit 124, a processor 125 and a storage 126.

The display 121 includes a panel such as an LCD panel or an OEL panel and displays various kinds of contents under the control of the display controller 122.

In accordance with the instruction given by the processor 125, the display controller 122 controls the display of various contents on the display 121.

The input unit 123 may be a keyboard or a command input button, for example, and sends a key input signal entered to the processor 125. Optionally, the display 121 and the input unit 123 may be integrated together so as to allow the user to operate a keyboard or common input buttons that are displayed on the display 121.

In accordance with the instruction given by the processor 125 in response to the key input signal that has been entered through the input unit 123, the communications unit 124 sends and receives various kinds of signals and information. For example, the communications unit 124 sends the first transmission request that has been gotten from the processor 125 to the broadcast receiving terminal 100 via a modem (not shown) that is connected to the broadcast receiving terminal 100. And the communications unit 124 receives the broadcast receiving terminal's (100) own unique identifier and the management server's (160) URL as a response to the first transmission request from the broadcast receiving terminal 100.

In addition, the communications unit 124 also sends a request for transmission of a portal site's URL (which will be referred to herein as a “second transmission request” and) which has been supplied from the processor 125 and the broadcast receiving terminal's (100) own unique identifier to the management server 160 via the wireless modem (not shown) that is connected to the broadcast receiving terminal 100. In this description, the “portal site” refers to a portal related to an area where the broadcast receiving terminal 100, identified by that identifier, is set up. Although a portal site is supposed to be selected in this embodiment by the area where the broadcast receiving terminal 100 is set up, this is just an example of the present disclosure. The portal site may also be selected by any other standard.

On receiving the second transmission request, the management server 160 transmits the URL of the portal site in question. And the communications unit 124 receives that URL. The communications unit 124 further receives a content, which is provided by the portal site with that URL, from the portal site. This is a content that has been sent from the portal site in response to a request for transmission of that content that has been sent from the processor 125.

In accordance with the key input signal that has been entered through the input unit 123, the processor 125 controls the display controller 122, the communications unit 124 and the storage 126. For example, in accordance with the key input signal that has been entered through the input unit 123, the processor 125 sends the first transmission request to the broadcast receiving terminal 100 via the communications unit 124. And the processor 125 receives the broadcast receiving terminal's (100) own unique identifier and the management server's (160) URL via the communications unit 124. Also, in accordance with the key input signal that has been entered through the input unit 123, the processor 125 sends the request for transmission of the portal site's URL (i.e., the second transmission request) and the broadcast receiving terminal's (100) own unique identifier to the management server 160 via the communications unit 124. And the processor 125 receives the portal site's URL from the management server 160 via the communications unit 124. Furthermore, in accordance with the key input signal that has been entered through the input unit 123, the processor 125 gets the content, which is provided by the portal site with that URL, received at the communications unit 124 and gets that content displayed on the display 121 by controlling the display controller 122.

The storage 126 stores the broadcast receiving terminal's (100) own unique identifier, the management server's (160) URL, and the portal site's URL, which have been received by the processor 125 via the communications unit 124.

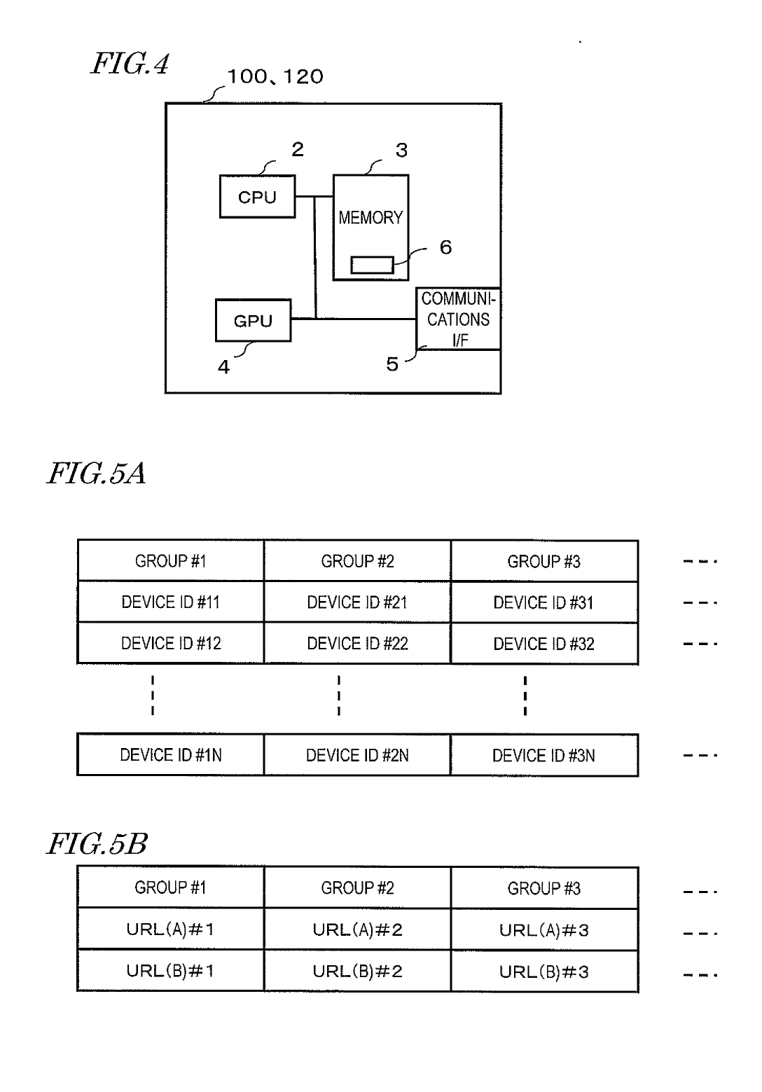

FIG. 4 illustrates an exemplary hardware configuration that can be used in common for each of the broadcast receiving terminal 100 and the mobile telecommunications terminal 120 (which will be collectively referred to herein as a “terminal 100, 120”). The terminal 100, 120 includes a CPU 2, a memory 3, a GPU 4, and a communications interface (I/F) 5.

The CPU 2 is a central processing unit that controls the overall operation of the terminal 100, 120. Also, the CPU 2 generates data to be transmitted to the communications I/F and processes the data that has been received at the communications I/F 5. The CPU 2 corresponds to the signal processor 101 and the processor 104 shown in FIG. 2 and to the processor 125 shown in FIG. 3.

The memory 3 is a so-called “storage device” such as a RAM, a ROM or a flash ROM. A computer program 6 is stored in the memory 3 and is executed by the CPU 2. Depending on what instruction codes are included in the computer program 6, the hardware shown in FIG. 4 functions as either the broadcast receiving terminal 100 or the mobile telecommunications terminal 120.

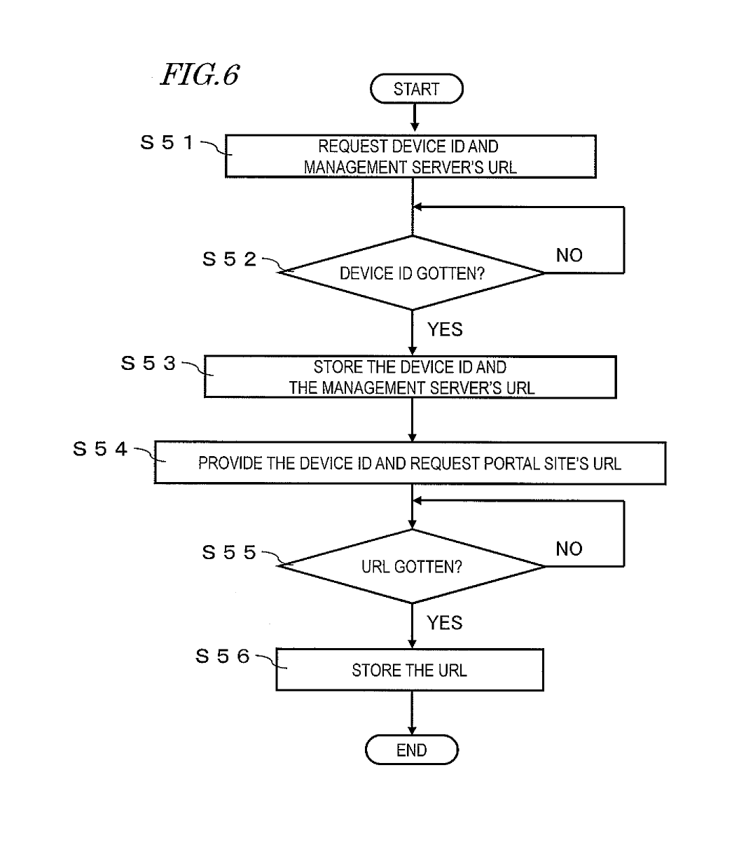

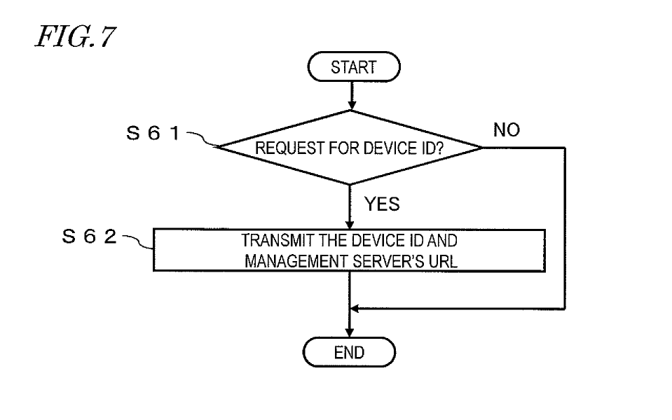

For example, if the instruction codes are written so as to perform the processing steps shown in FIG. 6 (to be described later), the hardware shown in FIG. 4 functions as the mobile telecommunications terminal 120. In that case, the computer program 6 makes the CPU 2 perform the respective processing steps shown in FIG. 6 using the communications unit 124 and other sections. On the other hand, if the instruction codes are written so as to perform the processing steps shown in FIG. 7 (to be described later), the hardware shown in FIG. 4 functions as the broadcast receiving terminal 100. In that case, the computer program 6 makes the CPU 2 perform the respective processing steps shown in FIG. 7 using the communications unit 103 and other sections.

Optionally, the terminal 100, 120 may be implemented as a DSP or any other piece of hardware in which a computer program has been installed in a single semiconductor integrated circuit.

The computer program 6 may be circulated on the market by being stored on a storage medium such as a CD-ROM or downloaded over telecommunications lines such as the Internet.

In FIG. 4, only one memory 3 is illustrated. However, this is just for convenience sake. Actually, multiple RAMs, ROMs or flash ROMs may be provided. The memory 3 corresponds to the storage s 105 and 126 shown in FIGS. 2 and 3.

The GPU 4 is a video processor that generates image data to display. Also, the GPU 4 outputs the image data generated through the communications I/F 5, thereby controlling display of the image. The GPU 4 corresponds to the display controllers 102 and 122 shown in FIGS. 2 and 3.

The communications I/F 5 is a generic term for various connection terminals. The communications I/F 5 may be an infrared ray receiver for a remote controller, an Ethernet™ terminal, a wireless communications antenna, an HDMI terminal or a DVI terminal, for example. The communications I/F 5 corresponds to a video output terminal (such as an HDMI terminal) that connects together the communications unit 103, the receiver 106, the display controller 102 and the TV monitor 110 shown in FIG. 2. The communications I/F 5 also corresponds to the communications unit 124 shown in FIG. 3.

The configuration shown in FIG. 4 does not include the display 121 of the mobile telecommunications terminal 120. However, the display 121 may be implemented as an LCD panel or an OEL panel as described above.

FIGS. 5A and 5B show the structure of the data that is stored in the management server 160 of this embodiment. It should be noted that the management server 160 may also have the hardware shown in FIG. 4. The data shown in FIGS. 5A and 5B is stored in the memory (such as a flash memory or a ROM) of the management server 160. Alternatively, the management server 160 may also store the data in a storage device such as a hard disk drive (HDD, not shown).

FIG. 5A shows a correspondence between each group number and its associated device IDs. When users subscribe to a broadcasting service, the broadcaster manages the device IDs of the broadcast receiving terminals (i.e., the broadcast receiving terminals' unique identifiers) that are set up in the users' houses by classifying those IDs into multiple groups on an area-by-area basis by reference to the subscribers' information. That is to say, the respective broadcast receiving terminals are grouped on the broadcaster's area basis.

FIG. 5B is a table of correspondence between the group numbers and the device IDs. As shown in this table, a broadcast receiving terminal having any of the device IDs #11, #12, . . . and #1N is classified into Group #1. In the same way, a broadcast receiving terminal having any of the device IDs #21, #22, . . . and #2N is classified into Group #2. The same can be said about the other groups, too. Each group number is associated with the area where the broadcast receiving terminals belonging to that group are set up. That is why a group number can be regarded as a piece of information indicating its associated area.

FIG. 5B is a table of correspondence between the group numbers and the portal sites' URLs. In FIG. 5B, shown are the URLs of portal sites to be accessed by the broadcast receiving terminal and mobile telecommunications terminal that are allocated to each group number. The URL of the portal site to be accessed by the broadcast receiving terminal that is allocated to Group #1 is URL(A)#1, while the URL of the portal site to be accessed by the mobile telecommunications terminal is URL(B)#1. Both of URL(A)#1 and URL(B)#1 are the URLs of portal sites that provide a content for the area where the broadcast receiving terminal classified into Group #1 is set up. In the same way, the URL of the portal site to be accessed by the broadcast receiving terminal that is allocated to Group #2 is URL(A)#2, while the URL of the portal site to be accessed by the mobile telecommunications terminal is URL(B)#2. The same can be said about the other groups.

The management server 160 can determine by reference to the user agent information that is included in an access request, for example, whether the communications terminal at the other end is the broadcast receiving terminal 100 or the mobile telecommunications terminal 120. The user agent information is included as a character string identifying each user agent within an HTTP request. By that character string, the name and version of the application, the host operating system and the language can be determined generally. By detecting the host operating system, for example, the management server 160 determines whether the communications terminal at the other end is the broadcast receiving terminal 100 or the mobile telecommunications terminal 120. Alternatively, to make the system operate smoothly, the request commands issued by the broadcast receiving terminal 100 and the mobile telecommunications terminal 120 may be different from each other.

Alternatively, the URL of the portal site accessed by the broadcast receiving terminal allocated to a certain group number may be the same as that of the portal site accessed by the mobile telecommunications terminal allocated to the same group number, device type information may be exchanged with the portal site, and a display operation may be performed according to the device type. In the example illustrated in FIG. 5B, each group includes the URL of only one portal site accessed by the mobile telecommunications terminal. However, each group may also include the URLs of respective portal sites accessed by multiple types of devices.

Hereinafter, it will be described with reference to FIGS. 6 through 8 how the mobile telecommunications terminal 120 operates. The mobile telecommunications terminal 120 receives the broadcast receiving terminal's (100) unique identifier and the management server's (160) URL from the broadcast receiving terminal 100, and then gets the portal site's URL from the management server 160 by using the broadcast receiving terminal's (100) identifier and the management server's (160) URL that have been received.

FIG. 6 is a flowchart showing the procedure of URL getting processing to be carried out by the mobile telecommunications terminal 120 according to this embodiment.

FIG. 7 is a flowchart showing the procedure of URL request response processing to be carried out by the broadcast receiving terminal 100 according to this embodiment.

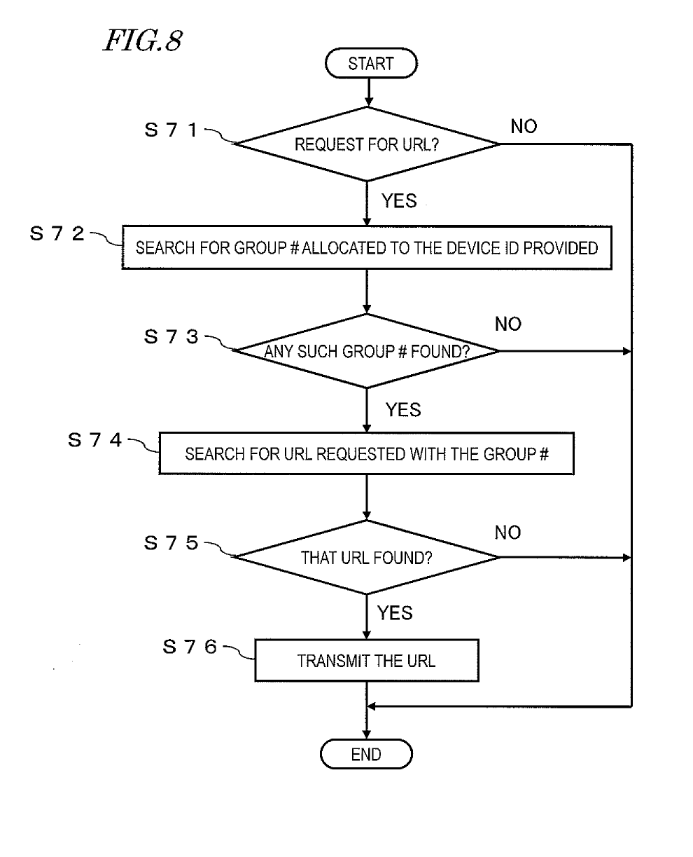

FIG. 8 is a flowchart showing the procedure of URL request response processing to be carried out by the management server 160 according to this embodiment.

First of all, look at FIG. 6.

When receiving a predetermined key input signal from the input unit 123, the processor 125 of the mobile telecommunications terminal 120 sends in Step S51 a request for transmission of the broadcast receiving terminal's (100) device ID (i.e., the broadcast receiving terminal's (100) own unique identifier) and the management server's (160) URL (i.e., sends the first transmission request) to the broadcast receiving terminal 100 via the communications unit 124.

Next, look at FIG. 7. When the broadcast receiving terminal 100 receives that request from the mobile telecommunications terminal 120, the processor 104 of the broadcast receiving terminal 100 determines whether that request is the first transmission request or not. In other words, the processor 104 determines whether the request is the mobile telecommunications terminal's (120) request for transmission of the device ID and the management server's (160) URL (in Step S61). When finding that request the first transmission request (i.e., if the answer to the query of the processing step S61 is YES), the processor 104 retrieves the device ID and the management server's (160) URL from the storage 105 and transmits them to the mobile telecommunications terminal 120 via the connected wireless modem (not shown)(in Step S62). In this manner, the broadcast receiving terminal 100 gets its processing done.

Now take a look at FIG. 6 again. The processor 125 of the mobile telecommunications terminal 100 gets the broadcast receiving terminal's (100) device ID and the management server's (160) URL via the communications unit 124. Therefore, the answer to the query of the processing step S52 is YES and the process advances to the next processing step S53, in which the processor 125 stores the broadcast receiving terminal's (100) device ID and the management server's (160) URL thus obtained in the storage 126.

Then, in Step S54, the processor 125 accesses the management server 160 with the URL thus obtained, notifies the management server 160 of the device ID just gotten, and requests the management server 160 to transmit the URL of a portal site that is associated with that device ID (i.e., sends a second transmission request).

At this stage, if the processor 125 gets the URL of the portal site to be accessed by the mobile telecommunications terminal 120 from the management server 160 through the processing steps shown in FIG. 8 to be described later (i.e., if the answer to the query of the processing step S55 is YES), the processor 125 stores the URL thus gotten in the storage 126 in Step S56.

After that, the processor 125 accesses the portal site with the URL that has just been gotten from the management server 160 (e.g., URL(B)#1 in the example described above). As a result, a content is provided by the target portal site for the user.

Hereinafter, it will be described with reference to FIG. 8 how the management server 160 operates.

When receiving a request from the mobile telecommunications terminal 120, the management server 160 determines whether that request is the second transmission request or not. That is to say, the management server 160 determines whether or not that request is a request for transmission of a portal site's URL (in Step S71). If the answer to the query of the processing step S71 is YES, then it means that the management server 160 has also been notified of the broadcast receiving terminal's (100) device ID. Then, the management server 160 searches the stored data for that device ID provided to find the group number allocated to that device ID (in Step S72). Specifically, the management server 160 searches the data shown in FIG. 5A for the group number that is allocated to the device ID provided. For example, if the device ID provided is device ID #11, the management server 160 search the data shown in FIG. 5A to find Group #1.

On the other hand, if the device ID provided or the group number allocated to the device ID provided cannot be found anywhere in the data shown in FIG. 5A (i.e., if the answer to the query of the processing step S73 is NO), the management server 160 ends its processing.

If the answer to the query of the processing step S73 is YES, then the process advances to the next processing step S74, in which the management server 160 searches for the URL of the portal site to be accessed by the mobile telecommunications terminal 120 that belongs to the group with the number allocated. Specifically, in that case, the management server 160 searches the data shown in FIG. 5B for the URL of the portal site to be accessed by the mobile telecommunications terminal 120 belonging to the group with the number allocated. For example, if the group number allocated is group #1, the management server 160 searches the data shown in FIG. 5B, thereby finding URL(B)#1 of the portal site to be accessed by the mobile telecommunications terminal 120. Then, the answer to the query of the processing step S75 is YES and the process advances to the next processing step S76.

On the other hand, if the management server 160 cannot find the URL of the portal site to be accessed by the mobile telecommunications terminal 120 in Group #1 with the number allocated even by searching the data shown in FIG. 5B (i.e., if the answer to the query of the processing step S75 is NO), then the management server 160 ends its processing. In that case, the management server 160 may notify the mobile telecommunications terminal 120 that the URL requested is not available.

Meanwhile, if the management server 160 has found the URL of the portal site to be accessed by the mobile telecommunications terminal 120 in the group with the number allocated, then the management server 160 transmits the URL of that portal site to the mobile telecommunications terminal 120 in Step S76.

On getting the portal site's URL, the processor 125 automatically accesses the portal site with that URL via the communications unit 124. As a result, the user no longer needs to enter the portal site's address by him- or herself.

As described above, in the mobile telecommunications terminal and URL receiving method using the mobile telecommunications terminal according to this embodiment, by using a system which is comprised of a management server and multiple broadcast receiving terminals that are connected together over a network and in which the management server manages the broadcast receiving terminal's own unique identifier and the URL of a portal site related to the area where the broadcast receiving terminal, identified by the identifier, is set up, the unique identifier and the management server's URL are received from the broadcast receiving terminal. And by using the broadcast receiving terminal's identifier and management server's URL thus received, the URL of the portal site related to the area where the broadcast receiving terminal, identified by that unique identifier, is set up is received from the management server. Consequently, it is possible to save the user the trouble of entering the URL of the portal site directly or selecting the portal site by him- or herself. In addition, the user can access the portal site related to the area where the broadcast receiving terminal is set up with the load imposed on the mobile telecommunications terminal lightened significantly.

### Embodiment 2

Hereinafter, configurations for a bidirectional broadcasting service system, broadcast receiving terminal, and mobile telecommunications terminal as a second embodiment of the present disclosure and, their processing will be described.

The system of this second embodiment is just different from the system 1 of the first embodiment described above in the structure of the data stored in the management server 160, the URL request response processing performed by the mobile telecommunications terminal 120 and the URL request response processing performed by the management server 160. In the other respects, the configurations of the bidirectional broadcasting service system, broadcast receiving terminal 100 and mobile telecommunications terminal 120 and the URL getting processing performed by the broadcast receiving terminal 100 according to this embodiment are the same as what has already been described for the first embodiment. Thus, any component of this second embodiment having substantially the same function as its counterpart of the first embodiment described above will be identified by the same reference numeral. And description of their common features will be omitted herein.

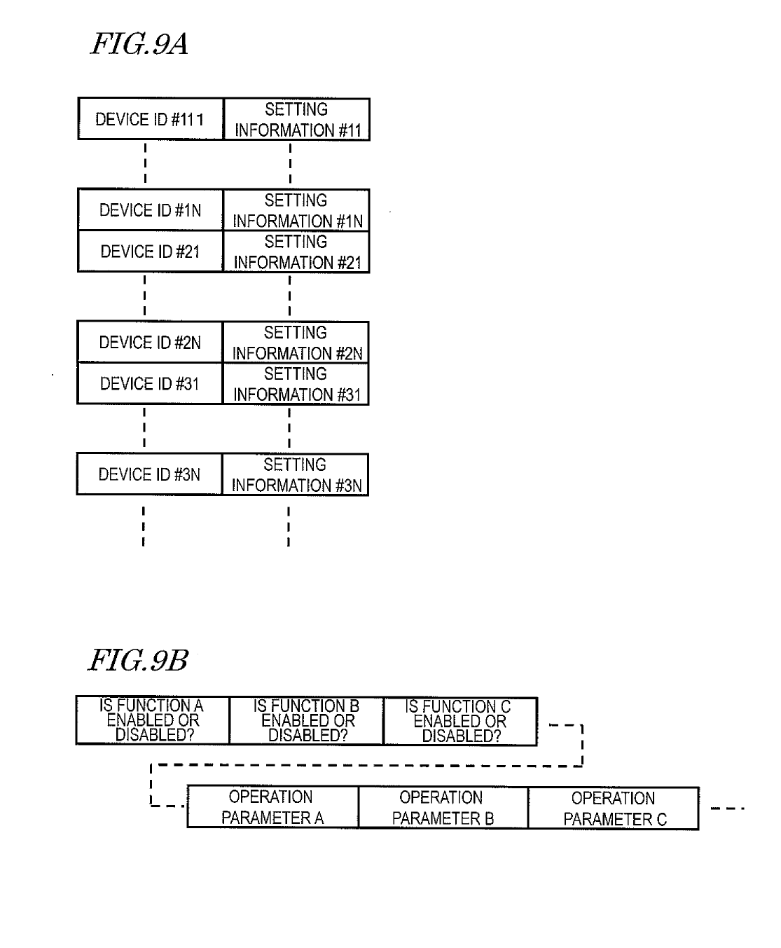

FIGS. 9A and 9B show the structure of the data stored in the management server 160 of this embodiment. The management server 160 stores not only the data shown in FIGS. 5A and 5B but also the data shown in FIGS. 9A and 9B.

The management server 160 stores setting information on a device ID basis.

FIG. 9A is a table of correspondence between respective device IDs and the setting information. For example, the management server 160 stores setting information #11 with respect to device ID #11.

FIG. 9B shows an example of the setting information that is stored in the management server 160.

The “setting information” is used by the mobile telecommunications terminal 120 when the terminal 120 is operating by accessing a portal site. Examples of the setting information include enabled or disabled states and operation parameters of various functions. For example, as shown in FIG. 9B, the setting information may be comprised of enabled or disabled state of Function A, enabled or disabled state of Function B, Operation Parameter A and Operation Parameter B. The enabled or disabled state of various functions may be whether the regular access function of the mobile telecommunications terminal 120 that can update the portal site information on a regular basis is enabled or disabled. Also, the operation parameter may be the interval of the regular access timing that is set with respect to the regular access function, for example. However, the setting information may be any other piece of information required for operation and does not have to be these pieces. For example, the setting information may include the URL of the target link, information indicating whether or not the mobile telecommunications terminal 120 may control the broadcast receiving terminal 100, and information about the user's contract plan.

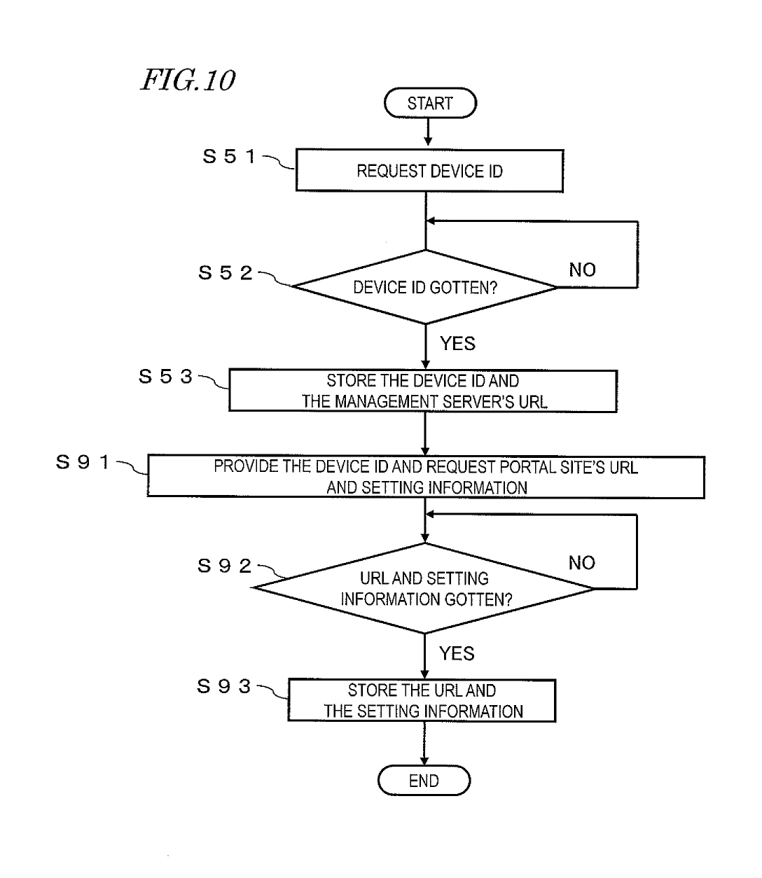

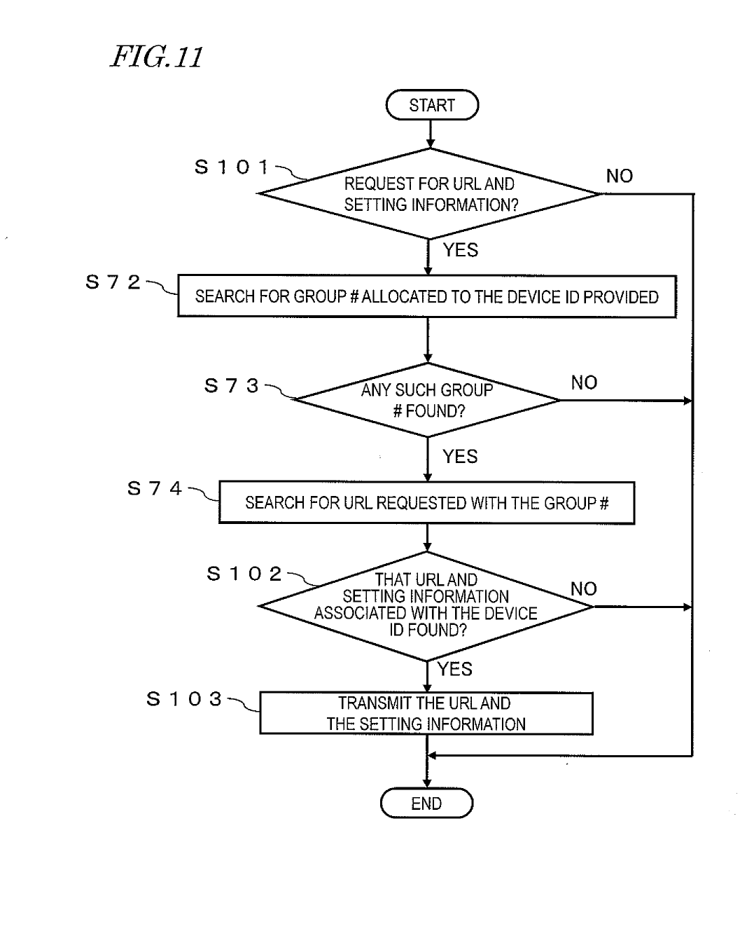

FIG. 10 is a flowchart showing the procedure of URL getting processing to be carried out by the mobile telecommunications terminal 120 of this embodiment.

FIG. 11 is a flowchart showing the procedure of URL request response processing to be carried out by the management server 160 of this embodiment.

In FIGS. 10 and 11, any processing step also shown in FIGS. 6 and 8 and having substantially the same function as its counterpart is identified by the same step number and description thereof will be omitted herein.

First of all, look at FIG. 10. The processor 125 of the mobile telecommunications terminal 120 performs processing steps S51 to S53. As a result, the processor 125 sends the device ID that has been gotten from the broadcast receiving terminal 100 to the management server 160 with the URL that has also been gotten from the broadcast receiving terminal 100. And the processor 125 requests the management server 160 to transmit the URL of the portal site associated with the device ID provided and setting information for the mobile telecommunications terminal 120 (in Step S91). In other words, the processor 125 sends not only the second transmission request but also a request for transmission of the setting information to the management server 160. In this description, the request for transmission of the portal site's URL and the request for transmission of the setting information for the mobile telecommunications terminal 120 will be collectively referred to herein as a “third transmission request”.

Next, look at FIG. 11.

The management server 160 determines in Step S101 whether or not the request received from the mobile telecommunications terminal 120 is the third transmission request. If the answer to the query of the processing step S101 is YES, then the management server 160 performs processing step S72, S73 and S74. Then, in Step S102, the management server 160 determines whether or not there is any piece of setting information that is associated with the URL and the device ID provided.

Suppose the device ID provided by the mobile telecommunications terminal 120 is device ID #11, for example. In that case, the management server 160 searches the data shown in FIGS. 5A and 5B to find URL(B)#1 of the portal site to be accessed by the mobile telecommunications terminal 120 belonging to Group #1 that is allocated to device ID #11. After that, the management server 160 further searches the data shown in FIG. 9A to find setting information #11 associated with device ID #11. Then, the answer to the query of the processing step S102 is YES and the process advances to the next processing step S103.

If the URL of the portal site to be accessed by the mobile telecommunications terminal 120 cannot be found in Group #1 allocated in the data shown in FIG. 5B or if the setting information #11 associated with the device ID #11 cannot be found in the data shown in FIG. 9A (i.e., if the answer to the query of the processing step S102 is NO), then the management server 160 ends its processing.

Nevertheless, even if the setting information #11 associated with the device ID #11 cannot be found in the data shown in FIG. 9A but if the URL of the portal site to be accessed by the mobile telecommunications terminal 120 is found in Group #1 allocated in the data shown in FIG. 5B, the answer to the query of the processing step S102 may be YES and the process may advance to the next processing step S103.

Thereafter, the management server 160 transmits the portal site's URL and the setting information associated with the device ID provided to the mobile telecommunications terminal 120 in Step S103. If the process has advanced to this processing step S103 even though the setting information associated with the device ID provided has not been found, then the management server 160 just transmits the URL to the mobile telecommunications terminal 120 without sending any setting information.

Now take a look at FIG. 10 again.

On getting the URL of the portal site to be accessed by the mobile telecommunications terminal 120 and the setting information associated with the device ID provided from the management server 160 (i.e., if the answer to the query of the processing step S92 is YES), the processor 125 of the mobile telecommunications terminal 120 stores the URL and the setting information in the storage 126 (in Step S93).

After that, the processor 125 of the mobile telecommunications terminal 120 makes predetermined settings based on the setting information associated with the device ID provided and gotten from the management server 160. And then the processor 125 accesses the portal site with the URL gotten and provides a content from that portal site for the user.

Although preferred embodiments of the present disclosure have been described, the present disclosure is in no way limited to those specific preferred embodiments but may be modified in various manners. For instance, although the portal site's URL to be received by the mobile telecommunications terminal 120 is supposed to be related to the area where the broadcast receiving terminal 100 is set up, this is only an example of the present disclosure. Alternatively, if the mobile telecommunications terminal 120 has a GPS capability and can provide location information, then that location information may also be transmitted. In that case, in order to get authenticated by the service subscriber, the mobile telecommunications terminal 120 needs to access the broadcast receiving terminal 100 and receive the URL of the management server 160. However, taking that location information into account, too, the management server 160 may transmit the URL of the portal site in the area including that location to the mobile telecommunications terminal 120.

In another modified example, the broadcast receiving terminal 100 may transmit information that identifies a program being received currently (which will be referred to herein as “program information”) to the mobile telecommunications terminal 120. And when the mobile telecommunications terminal 120 transfers that program information to the management server 160, the management server 160 can transmit information related to that program (e.g., the URL of a portal site in that area if the program is intended to introduce a local area) to the mobile telecommunications terminal 120. As a result, the user can easily get information that is exactly related to the program that he or she is currently viewing and listening to. As for the program information to transmit, if the broadcast is a digital one, the program information may be the even ID of service information (SI) included in a digital broadcasting stream or may also be the title of the program.

In the mobile telecommunications terminal and broadcast receiving terminal according to the embodiment of the present disclosure described above, by using a system which is comprised of a management server and multiple broadcast receiving terminals that are connected together over a network and in which the management server manages the broadcast receiving terminal's own unique identifier and the URL of a portal site related to the area where the broadcast receiving terminal, identified by the identifier, is set up, the unique identifier and the management server's URL are received from the broadcast receiving terminal. And by using the broadcast receiving terminal's identifier and management server's URL thus received, the URL of the portal site related to the area where the broadcast receiving terminal, identified by that unique identifier, is set up and setting information are received from the management server. Consequently, it is possible to save the user the trouble of entering the URL of the portal site directly or selecting the portal site by him- or herself. In addition, the user can access the portal site related to the area where the broadcast receiving terminal is set up with the load imposed on the mobile telecommunications terminal lightened significantly. On top of that, when the portal site is accessed using the setting information received, settings can be made appropriately.

The certain embodiments can be used effectively in a system comprised of a management server and multiple broadcast receiving terminals that are connected together over a network in order to have a mobile telecommunications terminal get the address of a portal site related to an area where the broadcast receiving terminal is set up from the management server.

While the present disclosure has been described with respect to preferred embodiments thereof, it will be apparent to those skilled in the art that the disclosed embodiments may be modified in numerous ways and may assume many embodiments other than those specifically described above. Accordingly, it is intended by the appended claims to cover all modifications of the disclosure that fall within the true spirit and scope of the disclosure.

This application is based on Japanese Patent Applications No. 2011-141362 filed on Jun. 27, 2011 and No. 2012-048018 filed on Mar. 5, 2012, the entire contents of which are hereby incorporated by reference.

What is claimed is:

1. A telecommunications terminal that is connected to a management server and a broadcast receiving terminal so as to communicate with each other,
wherein the broadcast receiving terminal stores an identifier to identify the broadcast receiving terminal itself uniquely and the address of the management server, and
wherein the management server stores information about correspondence between the identifier and the address of a predetermined portal site, and
wherein the telecommunications terminal comprises:
a processor configured to generate a first transmission request for transmission of the identifier and the address of the management server and a second transmission request for transmission of the address of the predetermined portal site; and
a communications unit configured to communicate with the broadcast receiving terminal and the management server, and
wherein after having sent the first transmission request to the broadcast receiving terminal, the communications unit receives the identifier and the address of the management server from the broadcast receiving terminal, when the communications unit sends the second transmission request and the identifier to the management server, thereby receiving the address of the predetermined portal site from the management server.

2. The telecommunications terminal of claim 1, further comprising a storage configured to store the address of the predetermined portal site that has been received.

3. The telecommunications terminal of claim 2, wherein after having received the address of the predetermined portal site from the management server, the processor accesses the predetermined portal site via the communications unit by using the address of the predetermined portal site.

4. The telecommunications terminal of claim 3, wherein the management server stores information about correspondence between the identifier and the address of the predetermined portal site related to an area where the broadcast receiving terminal, identified by the identifier, is set up, and
wherein the communications unit receives, from the management server, the address of the portal site related to the area where the broadcast receiving terminal is set up.

5. The telecommunications terminal of claim 1, wherein the processor further generates a setting information transmission request for transmission of setting information to be used by the telecommunications terminal itself that is operating by accessing the predetermined portal site, and
wherein the communications unit sends the setting information transmission request, along with the second transmission request and the identifier, to the management server, and further receives the setting information from the management server.

6. A broadcast receiving terminal that receives a broadcast signal and that is connected to a management server and a telecommunications terminal so as to communicate with each other,
wherein the management server stores information about correspondence between an identifier to identify the broadcast receiving terminal uniquely and the address of a predetermined portal site, and
wherein the telecommunications terminal is able to access the predetermined portal site by getting the address of the management server through a predetermined procedure, accessing the management server, and getting the address of the predetermined portal site from the management server, and
wherein the broadcast receiving terminal comprises:
a storage configured to store the identifier and the address of the management server;
a communications unit configured to receive a request for transmission of the identifier and the address of the management server from the telecommunications terminal; and
a processor configured to retrieve the identifier and the address of the management server from the storage on receiving the transmission request and that transmits the identifier and the address of the management server via the communications unit.

7. A computer program stored on a non-transitory computer readable medium, and to be executed by a computer that is built in a telecommunications terminal,
wherein the telecommunications terminal is connected to a management server and a broadcast receiving terminal so as to communicate with each other, and
wherein the broadcast receiving terminal stores an identifier to identify the broadcast receiving terminal itself uniquely and the address of the management server, and
wherein the management server stores information about correspondence between the identifier and the address of a predetermined portal site, and
wherein the computer program causes the computer perform the steps of:
sending a first transmission request for transmission of the identifier and the address of the management server to the broadcast receiving terminal;
receiving the identifier and the address of the management server from the broadcast receiving terminal;
sending the identifier and a second transmission request for transmission of the address of the predetermined portal site to the management server; and
receiving the address of the predetermined portal site from the management server.
